(19) United States
(12) Patent Application Publication
(10) Pub. No.: US 2026/0042193 A1
(43) Pub. Date: Feb. 12, 2026

(54) WRENCH STRUCTURE

(71) Applicant: Tsan-Chang Lee, Taichung City (TW)

(72) Inventor: Tsan-Chang Lee, Taichung City (TW)

(21) Appl. No.: 18/798,607

(22) Filed: Aug. 8, 2024

(51) Int. Cl. B25B 23/00; B25B 13/08; B25B 13/46

(52) U.S. Cl. CPC B25B 23/0028; B25B 13/08; B25B 13/461

(57) ABSTRACT

A wrench structure includes a first body, a second body, a first connecting member, and two pivot members. The first body is provided with a first pivot portion, two first recesses, and a first through hole. The second body is provided with a second pivot portion, a second recess, and a second through hole. The first connecting member is pivotally connected between the first body and the second body and has a first end provided with a third pivot portion, a third recess, and a third through hole and a second end provided with a fourth pivot portion, two fourth recesses, and a fourth through hole. One of the pivot members extends through the third through hole and the first through hole, and the other one the pivot members extends through the second through hole and the fourth through hole.

### BACKGROUND OF THE INVENTION

### Field Of The Invention

The present invention relates to a hand operated tool and, more particularly, to a wrench structure.

### Description of the Related Art

A conventional bendable spanner was disclosed in the U.S. Pat. No. 7,066,059, and comprises a driving head 1, a pivot unit 2, and a holding portion 3. The driving head 1 has a rear end pivotally connected with a front end of the pivot unit 2. The driving head 1 has a length L3. The pivot unit 2 has a rear end pivotally connected with a front end of the holding portion 3. The pivot unit 2 has a length L2. The holding portion 3 has a length L1. The length L1 is more than or equal to 1.5 times of the length L2, and is more than or equal to 1.15 times of the length L3.

However, such a conventional bendable spanner has the following disadvantages:
1. The pivot unit 2 is connected between the driving head 1 and the holding portion 3 to construct a three-stage pivotal mechanism. The number of the pivot unit 2 is fixed and cannot be added so that the pivotal mechanism of the conventional bendable spanner cannot be extended.
2. The driving head 1 is pivotally connected with the holding portion 3 by the pivot unit 2, but the conventional bendable spanner only has a driving mechanism served by the driving head 1, thereby limiting the utility of the conventional bendable spanner.

### BRIEF SUMMARY OF THE INVENTION

The primary objective of the present invention is to provide a wrench structure that constructs a pivotal mechanism with at least three stages.

In accordance with the present invention, there is provided a wrench structure comprising a first body, a second body, a first connecting member, and two pivot members. The first body is provided with a first pivot portion, two first recesses, and a first through hole. The second body is provided with a second pivot portion, a second recess, and a second through hole. The first connecting member has a first end pivotally connected with the first body and a second end pivotally connected with the second body. The first end of the first connecting member is provided with a third pivot portion, a third recess, and a third through hole. The second end of the first connecting member is provided with a fourth pivot portion, two fourth recesses, and a fourth through hole. One of the two pivot members extends through the third through hole and the first through hole, so that the first connecting member is pivotally connected with the first body. The other one the two pivot members extends through the second through hole and the fourth through hole, so that the first connecting member is pivotally connected with the second body.

According to the primary advantages of the present invention, the first connecting member is a Y-shaped piece. The first connecting member is pivotally connected between the first body and the second body, so that the wrench structure has a three-stage pivotal mechanism by serial connection of the first body, the first connecting member, the two pivot members, and the second body. Alternatively, the wrench structure has a multi-stage pivotal mechanism by serial connection of the first body, multiple first connecting members, multiple pivot members, and the second body.

According to another advantage of the present invention, the third pivot portion has a structure the same as that of the second pivot portion. The third recess has a structure the same as that of the second recess. The third through hole has a structure the same as that of the second through hole. The second screw portion has a structure the same as that of the first screw portion. The fourth pivot portion has a structure the same as that of the first pivot portion. The two fourth recesses have a structure the same as that of the two first recesses. The fourth through hole has a structure the same as that of the first through hole. Thus, the first body, the multiple first connecting members, the multiple pivot members, and the second body are connected serially and pivotally to construct the wrench structure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a wrench structure in accordance with the preferred embodiment of the present invention.

FIG. 2 is a schematic top view of a first connecting member of the wrench structure in accordance with the preferred embodiment of the present invention.

FIG. 3 is a perspective view of the wrench structure in accordance with the preferred embodiment of the present invention.

FIG. 4 is a top view of the wrench structure as shown in FIG. 3.

FIG. 5 is a cross-sectional view of the wrench structure taken along line A-A as shown in FIG. 4.

FIG. 6 is a perspective view of a wrench structure in accordance with the second preferred embodiment of the present invention.

FIG. 7 is a perspective view of a wrench structure in accordance with the third preferred embodiment of the present invention.

FIG. 8 is a perspective view of a wrench structure in accordance with the fourth preferred embodiment of the present invention.

### DETAILED DESCRIPTION OF THE INVENTION

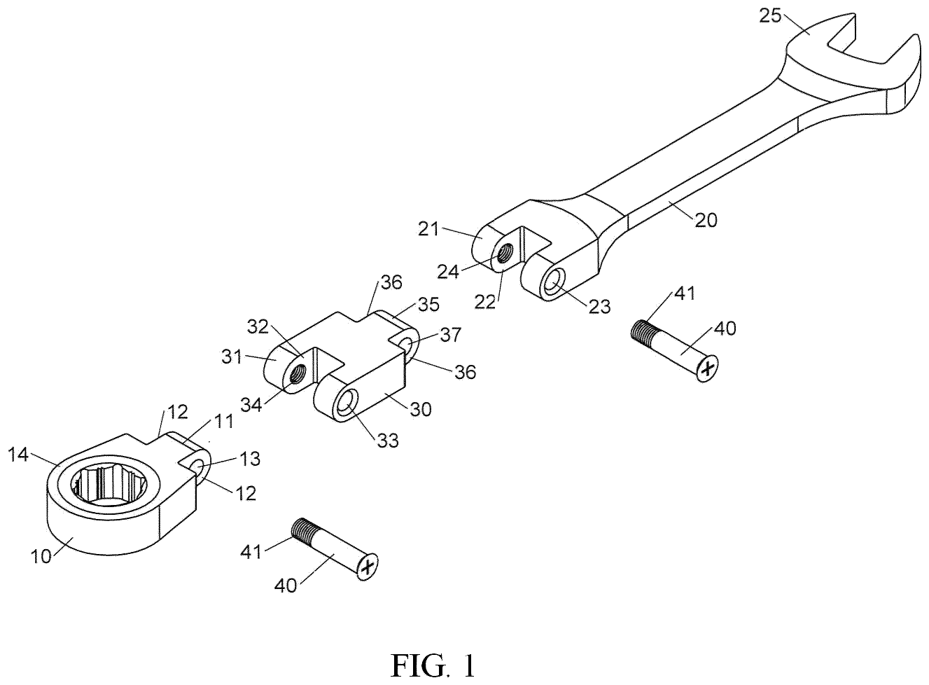

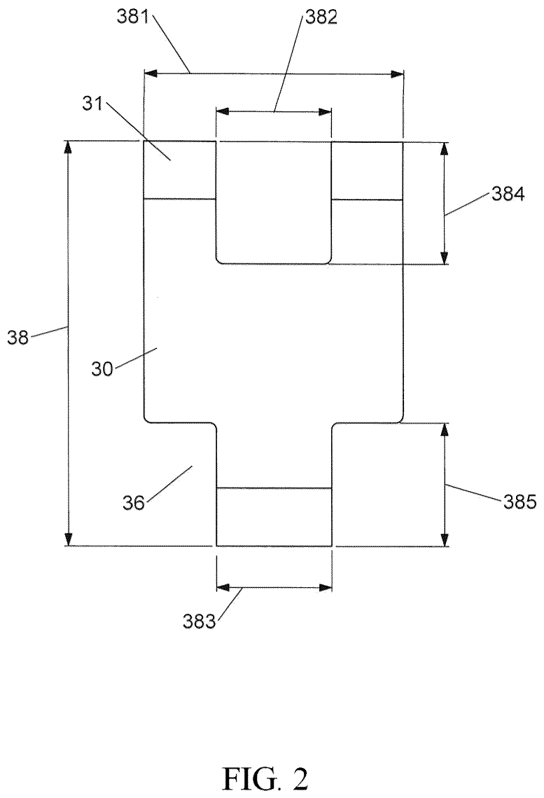

Referring to the drawings and initially to FIGS. 1-6, a wrench structure in accordance with the preferred embodiment of the present invention comprises a first body 10, a second body 20, a first connecting member 30, and two pivot (or fastening) members 40.

The first body 10 is a ratchet mechanism. The first body 10 has a first end provided with a first pivot portion 11. The first pivot portion 11 has two first recesses 12 formed on two sides thereof. The two first recesses 12 are arranged symmetrically relative to the first pivot portion 11. The first pivot portion 11 is provided with a first through hole 13 penetrating the first pivot portion 11 transversely. The first body 10 has a second end provided with a first operation (or action) portion 14.

The second body 20 is a wrench body. The second body 20 has a first end provided with a second pivot portion 21 having a U-shaped opening. The second pivot portion 21 has a middle provided with a second recess 22. The second pivot portion 21 is provided with a second through hole 23 transversely penetrating a first end of the second pivot portion 21. The second pivot portion 21 is provided with a first screw portion 24 transversely penetrating a second end of the second pivot portion 21. The first screw portion 24 is a screw hole. The second through hole 23 and the first screw portion 24 are located at the same axis. The second body 20 has a second end provided with a second operation (or action) portion 25 having an opening.

The first connecting member 30 has a first end pivotally connected with the first body 10 and a second end pivotally connected with the second body 20. The first connecting member 30 is disposed between the first body 10 and the second body 20.

The first connecting member 30 has a Y-shaped configuration. The first end of the first connecting member 30 is provided with a third pivot portion 31 pivotally connected with the first pivot portion 11. The third pivot portion 31 has a U-shaped opening and has a middle provided with a third recess 32. The first pivot portion 11 is mounted in the third recess 32. The third pivot portion 31 is provided with a third through hole 33 transversely penetrating a first end of the third pivot portion 31. The third pivot portion 31 is provided with a second screw portion 34 transversely penetrating a second end of the third pivot portion 31. The second screw portion 34 is a screw hole. The third through hole 33, the first through hole 13, and the second screw portion 34 are located at the same axis.

The third pivot portion 31 has a structure the same as that of the second pivot portion 21. The third recess 32 has a structure the same as that of the second recess 22. The third through hole 33 has a structure the same as that of the second through hole 23. The second screw portion 34 has a structure the same as that of the first screw portion 24.

The second end of the first connecting member 30 is provided with a fourth pivot portion 35 pivotally connected with the second pivot portion 21. The fourth pivot portion 35 is mounted in the second recess 22. The fourth pivot portion 35 has two fourth recesses 36 formed on two sides thereof. The two fourth recesses 36 are arranged symmetrically relative to the fourth pivot portion 35. The fourth pivot portion 35 is provided with a fourth through hole 37 penetrating the fourth pivot portion 35 transversely. The second through hole 23, the fourth through hole 37, and the first screw portion 24 are located at the same axis.

The fourth pivot portion 35 has a structure the same as that of the first pivot portion 11. The two fourth recesses 36 have a structure the same as that of the two first recesses 12. The fourth through hole 37 has a structure the same as that of the first through hole 13.

The first connecting member 30 has an overall length defining a first length 38. The first connecting member 30 has an overall width defining a first width 381. The third recess 32 has a width defining a second width 382. The fourth pivot portion 35 has a width defining a third width 383. The third recess 32 has a depth defining a second length 384. Each of the two fourth recesses 36 has a depth defining a third length 385.

The second width 382 has a value equal to that of the third width 383. The second length 384 has a value equal to that of the third length 385. The first length 38 has a value 1.5 to 2 times of that of the first width 381. The first length 38 has a value 2.5 to 3.5 times of that of the second length 384 or the first length 38 has a value 3 to 3.5 times of that of the second length 384. The first width 381 has a value 2 to 2.5 times of that of the second width 382 or the first width 381 has a value 2 to 2.2 times of that of the second width 382.

Each of the two pivot members 40 has a distal end provided with a third screw portion 41. The third screw portion 41 is an external thread. One of the two pivot members 40 extends through the third through hole 33 and the first through hole 13 and is screwed with the second screw portion 34, so that the first connecting member 30 is pivotally connected with the first body 10. The other one the two pivot members 40 extends through the second through hole 23 and the fourth through hole 37 and is screwed with the first screw portion 24, so that the first connecting member 30 is pivotally connected with the second body 20.

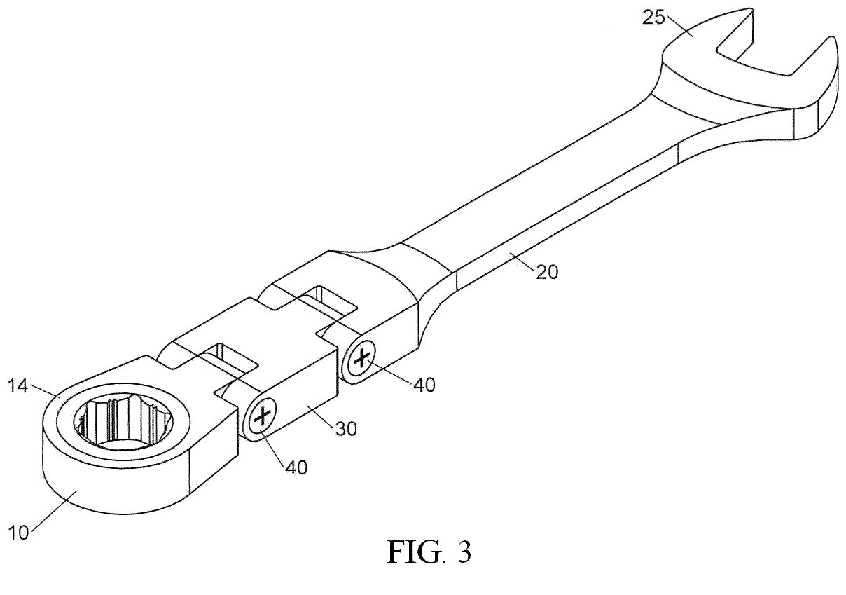

In operation, referring to FIG. 3 with reference to FIG. 1, when the second body 20 is driven and rotated by the user, the second body 20 drives the first connecting member 30, and the first connecting member 30 then drives the first body 10, to drive and rotate a screw member or socket.

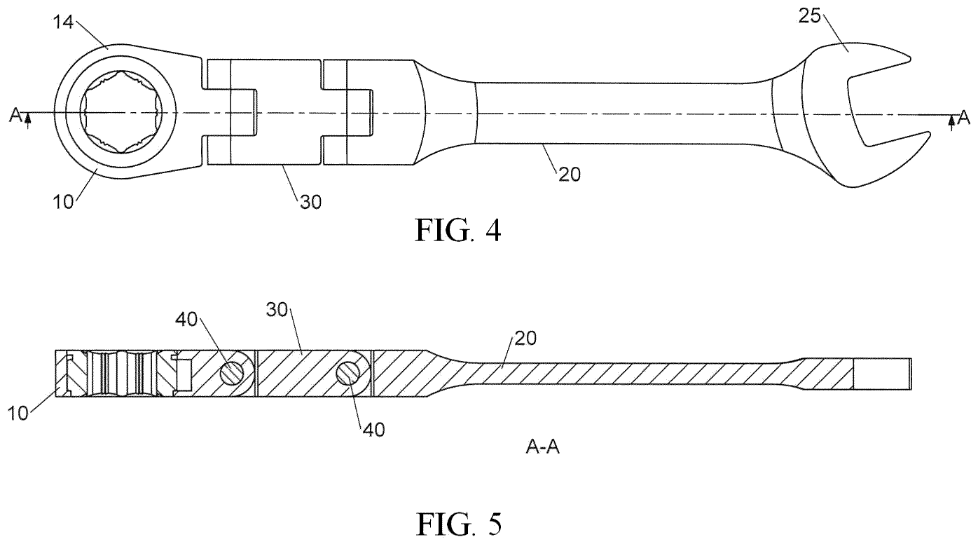

In assembly, referring to FIGS. 4 and 5 with reference to FIGS. 1-3, the third screw portion 41 of one of the two pivot members 40 extends through the third through hole 33 and the first through hole 13 and is screwed with the second screw portion 34, so that the third pivot portion 31 is pivotally connected with the first pivot portion 11, and the third screw portion 41 of the other one of the two pivot members 40 extends through the second through hole 23 and the fourth through hole 37 and is screwed with the first screw portion 24, so that the fourth pivot portion 35 is pivotally connected with the second pivot portion 21. Thus, the first body 10, the first connecting member 30, and the second body 20 are connected pivotally.

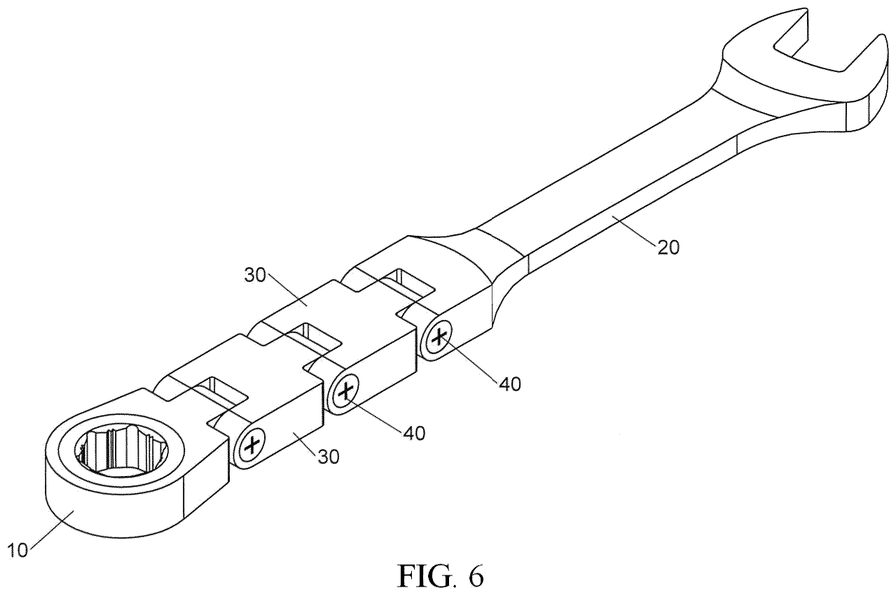

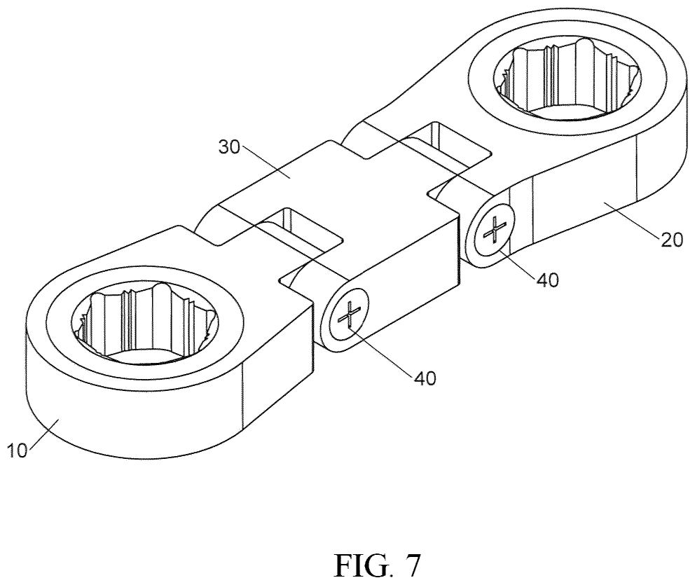

Referring to FIG. 6, the wrench structure comprises two first connecting members 30 and three pivot members 40, so that the first body 10, the two first connecting members 30, and the second body 20 are connected pivotally to construct a longer pivotal structure.

Similarly, the wrench structure comprises multiple first connecting members 30 and multiple pivot members 40, so that the first body 10, the first connecting members 30, the pivot members 40, and the second body 20 are connected serially and pivotally to construct a much longer pivotal structure. It is noted that the pivot members 40 have a number more than that of the first connecting members 30 by one.

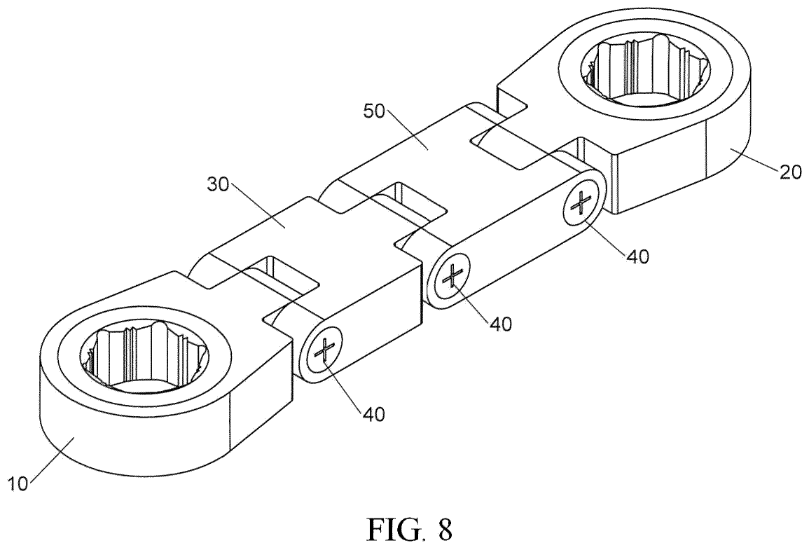

Referring to FIG. 7, each of the first body 10 and the second body 20 is a ratchet mechanism, and the first connecting members 30 has two ends pivotally connected with the first body 10 and the second body 20 respectively.

Referring to FIG. 8, each of the first body 10 and the second body 20 is a ratchet mechanism. The wrench structure further comprises a second connecting member 50. The second connecting member 50 is an H-shaped piece and has two opposite ends each of which is provided with t he third pivot portion 31, the third recess 32, the third through hole 33, and the second screw portion 34. The first connecting member 30 has a first end pivotally connected with the first body 10 and a second end pivotally connected with a first end of the second connecting member 50. The second connecting member 50 has a second end pivotally connected with the second body 20. Thus, the first body 10, the first connecting member 30, the second connecting member 50, and the second body 20 are connected serially and pivotally.

In another preferred embodiment of the present invention, the first body 10 is directly connected with the second body 20 pivotally. Thus, the first pivot portion 11 is mounted in the second recess 22.

Accordingly, the wrench structure of the present invention has the following advantages.

1. The first connecting member 30 is a Y-shaped piece. The first connecting member 30 is pivotally connected between the first body 10 and the second body 20, so that the wrench structure has a three-stage pivotal mechanism by serial connection of the first body 10, the first connecting member 30, the two pivot members 40, and the second body 20. Alternatively, the wrench structure has a multi-stage pivotal mechanism by serial connection of the first body 10, multiple first connecting members 30, multiple pivot members 40, and the second body 20.

2. The third pivot portion 31 has a structure the same as that of the second pivot portion 21. The third recess 32 has a structure the same as that of the second recess 22. The third through hole 33 has a structure the same as that of the second through hole 23. The second screw portion 34 has a structure the same as that of the first screw portion 24. The fourth pivot portion 35 has a structure the same as that of the first pivot portion 11. The two fourth recesses 36 have a structure the same as that of the two first recesses 12. The fourth through hole 37 has a structure the same as that of the first through hole 13. Thus, the first body 10, the multiple first connecting members 30, the multiple pivot members 40, and the second body 20 are connected serially and pivotally to construct the wrench structure.

3. The first body 10, the first connecting member 30, the two pivot members 40, and the second body 20 are connected pivotally. Alternatively, the first body 10, one of the two pivot members 40, and the second body 20 are connected pivotally to have a traditional pivotal structure. Thus, the wrench structure is expanded freely.

4. The first body 10 is provided with the first operation portion 14, and the second body 20 is provided with the second operation portion 25. The first operation portion 14 and the second operation portion 25 have different sizes and specifications. Thus, the wrench structure has two different sizes and specifications and is available for two different kinds of hand tools.

5. With reference to FIG. 8, each of the first body 10 and the second body 20 is a ratchet mechanism. The wrench structure further comprises a second connecting member 50. The second connecting member 50 is an H-shaped piece. Thus, the first connecting member 30 and the second connecting member 50 are pivotally connected between the first body 10 and the second body 20 to increase the whole pivotal structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A wrench structure comprising:
a first body, a second body, a first connecting member, and two pivot members;
wherein:
the first body has a first end provided with a first pivot portion;
the first pivot portion has two first recesses formed on two sides thereof;
the two first recesses are arranged symmetrically relative to the first pivot portion;
the first pivot portion is provided with a first through hole penetrating the first pivot portion transversely;
the first body has a second end provided with a first operation portion;
the second body has a first end provided with a second pivot portion having a U-shaped opening;
the second pivot portion has a middle provided with a second recess;
the second pivot portion is provided with a second through hole transversely penetrating a first end of the second pivot portion;
the second pivot portion is provided with a first screw portion transversely penetrating a second end of the second pivot portion;
the first screw portion is a screw hole;
the second through hole and the first screw portion are located at the same axis;
the second body has a second end provided with a second operation portion;
the first connecting member has a first end pivotally connected with the first body and a second end pivotally connected with the second body;
the first connecting member is disposed between the first body and the second body;
the first connecting member has a Y-shaped configuration;
the first end of the first connecting member is provided with a third pivot portion pivotally connected with the first pivot portion;
the third pivot portion has a U-shaped opening and has a middle provided with a third recess;
the first pivot portion is mounted in the third recess;
the third pivot portion is provided with a third through hole transversely penetrating a first end of the third pivot portion;
the third pivot portion is provided with a second screw portion transversely penetrating a second end of the third pivot portion;
the second screw portion is a screw hole;
the third through hole, the first through hole, and the second screw portion are located at the same axis;
the third pivot portion has a structure the same as that of the second pivot portion;
the third recess has a structure the same as that of the second recess;
the third through hole has a structure the same as that of the second through hole;
the second screw portion has a structure the same as that of the first screw portion;
the second end of the first connecting member is provided with a fourth pivot portion pivotally connected with the second pivot portion;
the fourth pivot portion is mounted in the second recess;
the fourth pivot portion has two fourth recesses formed on two sides thereof;
the two fourth recesses are arranged symmetrically relative to the fourth pivot portion;
the fourth pivot portion is provided with a fourth through hole penetrating the fourth pivot portion transversely;
the second through hole, the fourth through hole, and the first screw portion are located at the same axis;
the fourth pivot portion has a structure the same as that of the first pivot portion;
the two fourth recesses have a structure the same as that of the two first recesses;
the fourth through hole has a structure the same as that of the first through hole;
the first connecting member has an overall length defining a first length;
the first connecting member has an overall width defining a first width;
the third recess has a width defining a second width;
the fourth pivot portion has a width defining a third width;
the third recess has a depth defining a second length;
each of the two fourth recesses has a depth defining a third length;
the second width has a value equal to that of the third width;
the second length has a value equal to that of the third length;
the first length has a value 1.5 to 2 times of that of the first width;
the first length has a value 2.5 to 3.5 times of that of the second length or the first length has a value 3 to 3.5 times of that of the second length;
the first width has a value 2 to 2.5 times of that of the second width or the first width has a value 2 to 2.2 times of that of the second width;
each of the two pivot members has a distal end provided with a third screw portion;
the third screw portion is an external thread;
one of the two pivot members extends through the third through hole and the first through hole and is screwed with the second screw portion, so that the first connecting member is pivotally connected with the first body; and
the other one the two pivot members extends through the second through hole and the fourth through hole and is screwed with the first screw portion, so that the first connecting member is pivotally connected with the second body.

2. The wrench structure as claimed in claim 1, wherein the first body is a ratchet mechanism, and the second body is a wrench body.

3. The wrench structure as claimed in claim 1, wherein the wrench structure comprises two first connecting members and three pivot members, so that the first body, the two first connecting members, and the second body are connected pivotally to construct a longer pivotal structure.

4. The wrench structure as claimed in claim 1, wherein the wrench structure comprises multiple first connecting members and multiple pivot members, so that the first body, the first connecting members, the pivot members, and the second body are connected serially and pivotally, and the pivot members have a number more than that of the first connecting members by one.

5. The wrench structure as claimed in claim 1, wherein each of the first body and the second body is a ratchet mechanism, and the first connecting members has two ends pivotally connected with the first body and the second body respectively.

6. The wrench structure as claimed in claim 1, wherein:
each of the first body and the second body is a ratchet mechanism;
the wrench structure further comprises a second connecting member;
the second connecting member is an H-shaped piece and has two opposite ends each of which is provided with the third pivot portion, the third recess, the third through hole, and the second screw portion;
the first connecting member has a first end pivotally connected with the first body and a second end pivotally connected with a first end of the second connecting member;
the second connecting member has a second end pivotally connected with the second body; and
the first body, the first connecting member, the second connecting member, and the second body are connected serially and pivotally.
